(19) United States
(12) Patent Application Publication
(10) Pub. No.: US 2025/0355557 A1
(43) Pub. Date: Nov. 20, 2025

(54) CONTROL METHOD AND CONTROL APPARATUS

(71) Applicant: Lenovo (Beijing) Limited, Beijing (CN)

(72) Inventors: Pengfei SHAO, Beijing (CN); Yanan CUI, Beijing (CN); Ying HUANG, Beijing (CN)

(21) Appl. No.: 19/194,075

(22) Filed: Apr. 30, 2025

(30) Foreign Application Priority Data
May 15, 2024 (CN) 202410606387.9

(51) Int. Cl. G06F 3/04886; G06F 3/04883

(52) U.S. Cl. CPC G06F 3/04886; G06F 3/04883

(57) ABSTRACT

A control method includes obtaining a touch operation, and in response to the touch operation, controlling an input state of an electronic device. The input state of the electronic device at least includes a first input state and a second input state. In the first input state, a first display area of the electronic device displays a first touch area. In the second input state, the first display area of the electronic device displays a second touch area that at least covers a portion of the first touch area.

### CROSS-REFERENCE TO RELATED APPLICATION

The present disclosure claims priority to Chinese Patent Application No. 202410606387.9, filed on May 15, 2024, the entire content of which is incorporated herein by reference.

### TECHNICAL FIELD

The present disclosure is related to the electronic device control technology field and, more particularly, to a control method and a control apparatus.

### BACKGROUND

With the development of touch screens, users sometimes do not use physical keyboards and touchpads but directly use screens for touch control. Currently, a display area of an electronic device displays a keyboard touch area and a touchpad area. The keyboard touch area and the touchpad area take a large display space on the display area when being displayed separately. Since users often only need to use one of the keyboard touch area and the touchpad area to input information, an excessive display area is taken by the keyboard touch area and the touchpad area. In addition, displaying both the keyboard touch area and the touchpad area increases the probability of mistouches by the users.

### SUMMARY

An aspect of the present disclosure provides a control method. The method includes obtaining a touch operation, and in response to the touch operation, controlling an input state of an electronic device. The input state of the electronic device at least includes a first input state and a second input state. In the first input state, a first display area of the electronic device displays a first touch area. In the second input state, the first display area of the electronic device displays a second touch area that at least covers a portion of the first touch area.

An aspect of the present disclosure provides a control apparatus, including one or more processors and one or more memories. The one or more memories store computer instructions that, when executed by the one or more processors, cause the one or more processors to obtain a touch operation, and in response to the touch operation, control an input state of an electronic device. The input state of the electronic device at least includes a first input state and a second input state. In the first input state, a first display area of the electronic device displays a first touch area. In the second input state, the first display area of the electronic device displays a second touch area that at least covers a portion of the first touch area.

### BRIEF DESCRIPTION OF THE DRAWINGS

FIG. 1 illustrates a schematic flowchart of a control method according to some embodiments of the present disclosure.

FIG. 2 illustrates a schematic diagram showing a first display area of an electronic device using a control method, the electronic device being in a first input status.

FIG. 3 illustrates a schematic diagram showing a first display area of an electronic device using a control method, the electronic device being in a second input status.

FIG. 4 illustrates a schematic flowchart of another control method according to some embodiments of the present disclosure.

FIG. 5 illustrates a schematic flowchart of another control method according to some embodiments of the present disclosure.

FIG. 6 illustrates a schematic diagram showing a first display area of an electronic device using a control method, the electronic device being in a third input status.

FIG. 7 illustrates a schematic diagram showing a first display area of an electronic device using a control method, the electronic device being in a second input status.

FIG. 8 illustrates a schematic structural diagram of a control apparatus according to some embodiments of the present disclosure.

### DETAILED DESCRIPTION OF THE EMBODIMENTS

Various modifications can be made to embodiments of the present disclosure. Therefore, the above description should not be regarded as limiting but merely as examples of embodiments of the present disclosure. Those skilled in the art can think of other modifications within the scope and spirit of the present disclosure.

The accompanying drawings included in and forming a part of the specification illustrate embodiments of the present disclosure. The accompanying drawings with the general description of the present disclosure given above and the detailed description of embodiments of the present disclosure given below are used to explain the principles of the present disclosure.

These and other characteristics of the present disclosure become apparent through the following description of preferred embodiments, given as non-limiting examples, with reference to the accompanying drawings.

Although the present disclosure has been described with reference to some specific examples, those skilled in the art can certainly implement many other equivalent forms of the present disclosure.

In conjunction with the accompanying drawings, the above and other aspects, features, and advantages of the present disclosure become more apparent according to the following detailed description.

Embodiments of the present disclosure are described hereafter with reference to the accompanying drawings. However, the described embodiments are merely examples of the present disclosure, which can be implemented in various ways. Well-known and/or repetitive functions and structures are not described in detail to avoid unnecessary or redundant details that may obscure the present disclosure. Accordingly, the specific structural and functional details are not intended to be limiting but serve merely as a basis for the claims and as a representative basis for teaching those skilled in the art to employ the present disclosure in virtually any suitably detailed structure.

The specification may use the phrases “in one embodiment,” “in another embodiment,” “in yet another embodiment,” or “in other embodiments,” which can refer to one or more of same or different embodiments of the present disclosure.

Embodiments of the present disclosure provide a control method. The control method can be applied to an electronic device. The electronic device can include various devices such as smartphones, tablets, laptops, etc., which are not limited in the present disclosure.

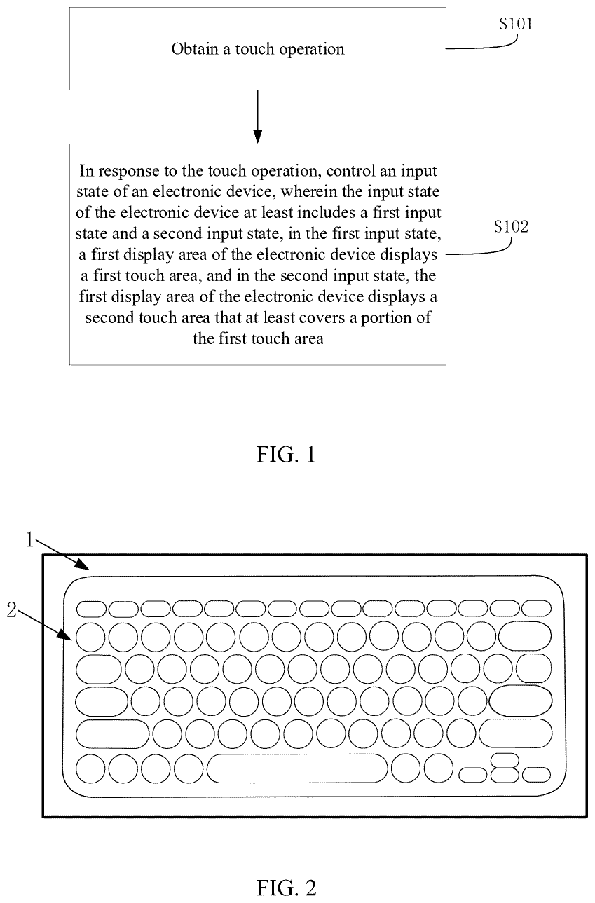

As shown in FIG. 1, the control method includes steps S101 and S102.

At S101, a touch operation is obtained.

At S102, in response to the touch operation, the input state of the electronic device is controlled. The input state of the electronic device includes at least a first input state and a second input state. In the first input state, a first touch area 2 is displayed within a first display area 1 of the electronic device, and in the second input state, a second touch area 3 covering at least a part of the first touch area 2 is displayed within the first display area 1 of the electronic device.

The above touch operation can be understood as a gesture operation performed by the user on the electronic device or a touch-based operation performed by the user on the electronic device. The present disclosure does not impose specific limitations on the method of the touch operation, as long as the user can perform the operation conveniently.

The differences in the input state of the electronic device can be different input methods or different input contents, which are not limited. Different input states can satisfy different input requirements of the user to adapt to multiple input scenarios.

In addition to the first display area 1, the electronic device can also include a second display area. The second display area can cooperate with the first display area 1 for display or can display the input content entered by the user in the first display area 1. For example, the electronic device can be a dual-screen device. One screen can be configured as the first display area 1 and the other screen can be configured as the second display area. The user can perform input operations in the first display area 1, while the second display area can display the input content corresponding to the input operations.

The difference between the first touch area 2 and the second touch area 3 can have different touch operation methods or different input contents generated after the touch. For example, the input method for the first touch area 2 can involve a key-based input via a virtual keyboard, while the input method for the second touch area 3 can involve a gesture-based input via a virtual touchpad. The above are merely examples, which are not limited in the present disclosure. For example, the following description is made by taking the first touch area 2 as the virtual keyboard area and the second touch area 3 as the virtual touchpad area.

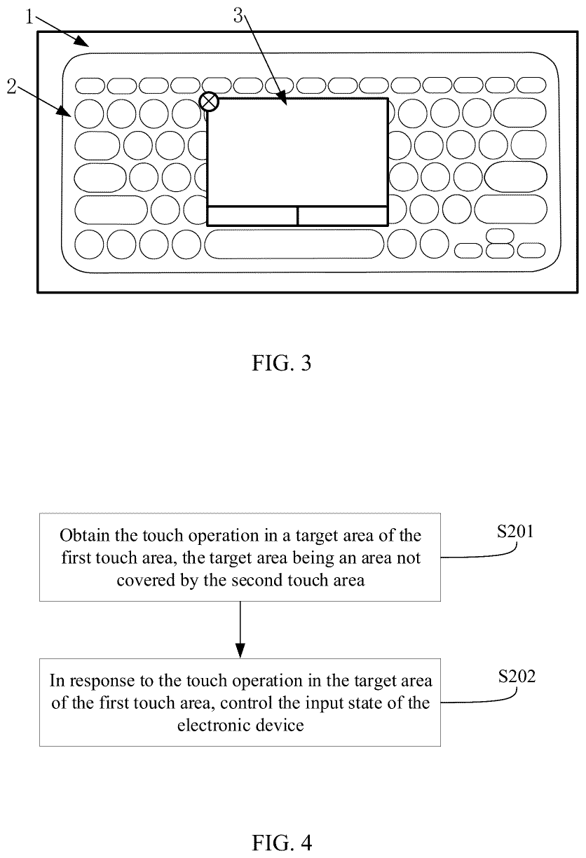

As shown in FIGS. 2 and 3, the electronic device of FIG. 2 is in the first input state. In the first input state, the first display area 1 of the electronic device only includes the virtual keyboard area. In the first input state, the user can only perform input through the virtual keyboard area of the first display area 1. The electronic device of FIG. 3 is in the second input state. In the second input state, the second electronic device of the electronic device can be in the second input state. In the second input state, the first display area 1 of the electronic device includes the virtual keyboard area and the virtual touchpad area. In the second input state, the user can perform input through the virtual keyboard area and the virtual touchpad area of the first display area 1 or only through the virtual touchpad area of the first display area 1.

The area of the first touch area 2 can be greater than or equal to the area of the second touch area 3. The second touch area 3 can partially overlap with the first touch area 2 or can entirely cover the first touch area 2. Moreover, the first touch area 2 can include a portion not covered by the second touch area 3.

For example, as shown in FIG. 3, the second touch area 3 entirely covers the first touch area 2, and a portion of the first touch area 2 is not covered by the second touch area 3.

In some embodiments, the portion of the first touch area 2 covered by the second touch area 3 can be located anywhere on the first touch area 2, for example, the center portion shown in FIG. 3, or the left portion or the right portion not shown in the figure. The portion covered by the second touch area 3 can also be set by the user to align with user operating habits.

In some embodiments, controlling the input state of the electronic device can be implemented by a control program or a control module, which is not limited in the present disclosure. The microcontroller unit (MCU) of the electronic device can, after detecting the user touch operation, send a control instruction generated based on the touch operation to the control program or the control module to control the input state of the electronic device by the control program or the control module.

In the present disclosure, the input state of the electronic device can be controlled through the touch operation to allow the electronic device to at least switch between the first input state and the second input state. In the first input state, the electronic device can display the first touch area 2, while in the second input state, the electronic device can display the second touch area 3, covering at least a part of the first touch area 2. Thus, the electronic device can display different touch areas after the user performs simple touch operations to satisfy the input requirements of the user in different situations. Moreover, in the second input state, the area of the display area of the electronic device taken by the touch area can be effectively reduced to allow the electronic device to have a larger display space.

In some embodiments, as shown in FIG. 4, in step S101, obtaining the touch operation includes step S201.

At S201, the touch operation in a target area of the first touch area 2 is obtained. The target area is an area not covered by the second touch area 3.

In S102, controlling the input state of the electronic device in response to the touch operation can include step S202.

At S202, in response to the touch operation in the target area of the first touch area 2, the input state of the electronic device is controlled.

Thus, the touch operation can occur in the target area of the first touch area 2. Thus, the electronic device can detect the touch operation in the target area to effectively avoid mis-operations to make the detection of the touch operation more precise to more accurately switch the input states of the electronic device.

The target area can be located within the first touch area 2. The user can switch the input state of the electronic device from the first input state to the second input state without moving the fingers away from the first touch area 2, which is convenient for the user to operate.

In some embodiments, the touch operation on the target area can be a single-finger or multi-finger operation of the user, which is not limited in the present disclosure. In some embodiments, the touch operation can be a single-finger operation, for example, the user can use the thumb to perform the single-finger operation to switch the input state without requiring additional operations, which improves operation convenience.

The target area can be a fixed area within the first touch area 2. For example, if the first touch area 2 is a virtual keyboard area, the target area can be an area of one or more keys on the virtual keyboard. For example, the area of the space key can be the target area.

In some embodiments, in the first input state and/or the second input state, after obtaining the operation on the target area, whether the operation is an input operation or a touch operation can be determined. If the operation is the input operation, the input state can remain, and the input content corresponding to the target area of the first touch area 2 can be output in the current input state. When the operation is a touch operation, the input state can be determined to be switched, and the input content corresponding to the target area may not be outputted.

For example, when the target area is the area corresponding to the space key, after the user performs the operation on the space key, whether the operation is the input operation of inputting the space key or the touch operation of switching the input state can be determined. When the operation is the input operation, the input state can be determined to be not switched. Moreover, in the current input state, the input content corresponding to the space key can be outputted. When the operation is the touch operation, switching of the input state can be determined without outputting the input content corresponding to the space key.

In some embodiments, the method for determining the input operation and the touch operation can be identified by the operation method of the user. If the user only clicks on the target area, the operation can be determined as the input operation. If the user swipes to trigger the target area, the operation can be determined as the touch operation. The method for determining the input operation and the touch operation is an example, which is not limited in the present disclosure.

In some embodiments, the method further includes the following processes.

When the electronic device is in the first input state, and the first touch operation obtained in the target area of the first touch area 2 is the first touch operation, the electronic device can be controlled to enter the second input state.

When the electronic device is in the second input state, and the touch operation obtained in the target area of the first touch control area 2 is the second touch operation, the electronic device can be controlled to enter the first input state.

Thus, the electronic device can switch between the first input state and the second input state. Moreover, the input state of the electronic device can be precisely controlled through the different first touch operation and the second touch operation.

The touch operation and input operation can differ at least in operation methods. For example, the input operation can be a tap operation, while the touch operation can be a swipe operation. The input operation can be a normal input operation performed by the user in the current input state, not an operation for switching the input state. For example, when the user uses the virtual keyboard, the tap operation performed on the keys of the virtual keyboard can be the input operation, and the swipe operation performed on the keys of the virtual keyboard can be the touch operation.

The first touch operation and second touch operation can differ at least in the operation methods. For example, the first touch operation can be a left swipe, and the second touch operation can be a right swipe. With the different operation methods, the accuracy of switching the input state can be ensured. Of course, the first touch operation being a left swipe, and the second touch operation being a right swipe are merely examples, which are not limited in the present disclosure.

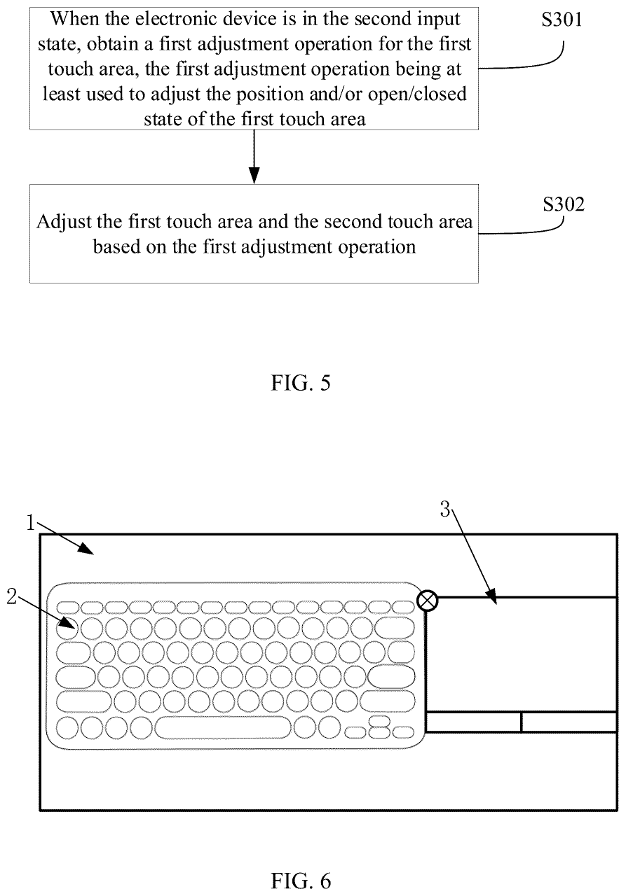

In some embodiments, as shown in FIG. 5, the method further includes steps S301 and S302.

At S301, when the electronic device is in the second input state, a first adjustment operation for the first touch area 2 is obtained. The first adjustment operation is at least used to adjust the position and/or open/closed state of the first touch area 2.

At S302, the first touch area 2 and the second touch area 3 are adjusted based on the first adjustment operation.

Thus, the first touch area 2 and the second touch area 3 can be adjusted simultaneously in the second input state. For example, the first touch area 2 and the second touch area 3 can be closed, or the positions of the first touch area 2 and the second touch area 3 can be simultaneously adjusted to simplify the operation of the user for controlling the first touch area 2 and the second touch area 3. Then, the operation convenience can be improved.

In some embodiments, the operation methods for the first adjustment operation and the touch operation can be different to cause the electronic device to differentiate the first adjustment operation and the touch operation.

Simultaneously adjusting the first touch area 2 and the second touch area 3 can include adjusting the position of the first touch area 2 through the first adjustment operation, which can cause the position of the second touch area 3 to be adjusted. In some other embodiments, by adjusting the open and close of the first touch area 2 through the first adjustment operation, the open and close of the second touch area 3 can also be adjusted accordingly. For example, the user closes the first touch area 2, the second touch area 3 can still be closed.

In some embodiments, the method can further include the following processes.

When the electronic device is in the second input area, the portion of the first touch area 2 that is not covered by the second touch area 3 can be in a non-response state.

In response to the close operation on the second touch area 3, the electronic device can be controlled to switch the second input state into the first input state.

Then, in the second input state, the first touch area 2 that is not covered by the second touch area 3 can be in the non-response state, and the mis-operation on the first touch area 2 can be prevented in the second input state. Thus, the user can perform input accurately through the second touch area 3.

In the non-response state of the first touch area 2, no input content can be generated even if the user triggers the first touch area 2. Thus, in the second input state, the electronic device can only respond through the second touch area 3.

In some embodiments, when the first touch area 2 that is not covered by the second touch area 3 is in the non-response state, the user can generate the close operation through a close option in the second touch area 3 to close the second touch area 3. In some embodiments, as shown in FIG. 3, the “x” mark on the upper left corner in the second touch area 3 is the open and close option of the second control area 3.

In some embodiments, the transparency of the second touch area 3 can be adjusted to allow the user to view the first touch area 2 that is covered by the second touch area 3. Even though the transparency of the second touch area 3 is adjusted, the first touch area 2 is still in the non-response state in the second input state. The response priority of the second touch area 3 can be higher than the response priority of the first touch area 2. When the second touch area 3 is the virtual touchpad area, adjusting the transparency of the second touch area 3 can include adjusting the transparency of the non-frame area of the virtual touchpad area. The frame of the virtual touchpad can be displayed solidly to allow the user to identify the area of the virtual touchpad.

In some embodiments, the method further includes the following processes.

When the electronic device is in the second input state, the portion of the first touch area 2 that is not covered by the second touch area 3 can be in the response state.

In response to the trigger operation in the target area of the first touch area 2, the electronic device can be controlled to switch from the second input state to the first input state.

In some other embodiments, in response to the selection operation on the close option of the second touch area 3, the electronic device can be controlled to switch from the second input state to the first input state.

Thus, in the second input state, through the response state of the portion of the first touch area 2 that is not covered by the second touch area 3, the input can be performed on the portion of the first touch area 2 that is not covered by the second touch area 3 and on the second touch area 3 in the second input state to satisfy the multiple input requirements of the user in the second input state.

In the response state of the first touch area 2, when the user triggers the first touch area 2, the corresponding input content can be generated. Thus, in the second input state, the electronic device can respond through the portion of the first touch area 2 that is not covered by the second touch area 3 and the second touch area 3.

When the target area of the first touch area 2 is not covered by the second touch area 3, the electronic device can switch the input state through the touch operation in the target area, or through the selection operation on the close option in the second touch area 3.

When the target area of the first touch area 2 is covered by the second touch area 3, the electronic device cannot switch the input state through the touch operation in the target area. The electronic device can switch the input state through the selection operation on the close option in the second touch area 3.

In some embodiments, the input state of the electronic device can further include a third input state. The method can further include the following processes.

When the obtained touch operation indicates that the electronic device enters the third input state, the first touch area 2 and the second touch area 3 can be displayed side by side.

When the position of one of the first touch area 2 and the second touch area 3 is adjusted in the third input state, the position of the other one can change synchronously to allow the first touch area 2 and the second touch area 3 to remain displaying independently.

Thus, by providing the third input state to the user, the electronic device can have various input methods. In the third input state, the first touch area 2 and the second touch area 3 can be displayed side by side to allow the user to perform different operations in different areas to satisfy the user needs of performing the input simultaneously through the first touch area 2 and the second touch area 3.

The first touch area 2 and the second touch area 3 being displayed side by side can include displaying the first touch area 2 and the second touch area 3 at positions of the electronic device without an overlapped portion between the first touch area 2 and the second touch area 3. Displaying the first touch area 2 and the second touch area 3 side by side can include arranging the first touch area 2 and the second touch area 3 close to each other, e.g., in an up-and-down layout method and in a left and right layout method.

For example, as shown in FIG. 6, the first touch area 2 and the second touch area 3 are arranged in the left and right layout method.

In the third input state, the first touch area 2 and the second touch area 3 can be adjusted synchronously. For example, when the position of the first touch area 2 is adjusted, the second touch area 3 can also be adjusted accordingly to the position close to the first touch area 2, and the first touch area 2 and the second touch area 3 can remain being displayed side by side.

In some embodiments, the method can further include obtaining the second adjustment operation for adjusting the second touch area 3 and adjusting the display parameter of the second touch area 3 at least in the second input state based on the second adjustment operation.

Then, by adjusting the second touch area 3, the display parameter of the second touch area 3 in the second input state can be adjusted to cause the display parameter of the second touch area to better satisfy the user needs and improve the user experience.

The above display parameter can include one or more of the following parameters, e.g., display position, display effect, and display size.

In some embodiments, adjusting of the display parameters of the second touch area 3 in the second input state based on the second adjustment operation can specifically include, based on the second adjustment operation, adjusting at least one of the display position, display effect, or display size of the second touch area 3 within the range of the first touch area 2 in the second input state.

Thus, by adjusting the display parameters of the second touch area 3 within the range of the first touch area 2 in the second input state, the flexibility of adjusting the second touch area 3 within the range of the first touch area 2 can be improved, while the second touch area 3 can cover at least a part of the first touch area 2, thereby not increasing the occupied display area of the electronic device.

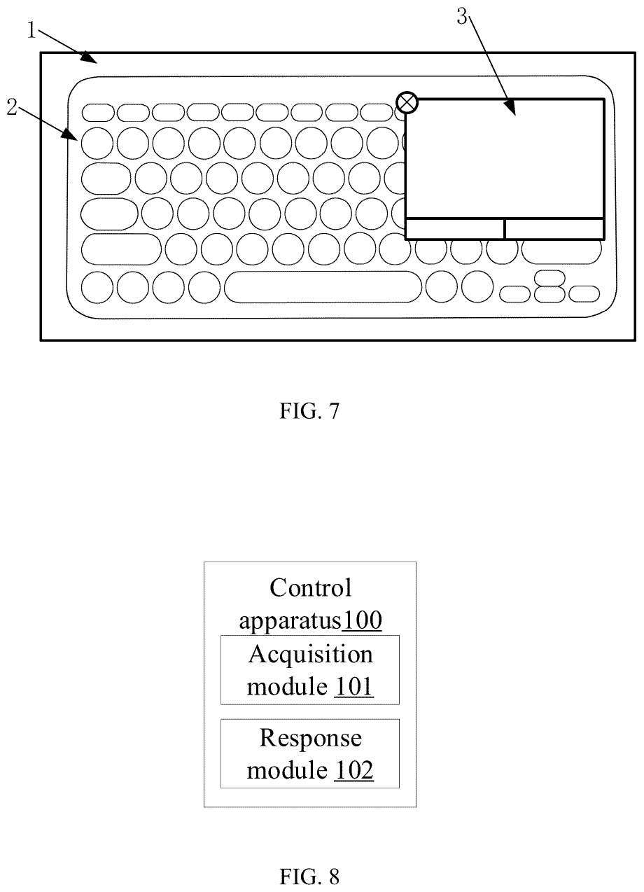

As shown in FIGS. 3 and 7, FIG. 3 shows that the second touch area 3 is at the first position in the second input state, and FIG. 7 shows that the second touch area 3 is at the second position in the second input state. The position of the second touch area 3 is adjusted within the range of the first touch area 2, which ensures that the second touch area 3 covers at least a part of the first touch area 2.

In some embodiments, the first touch area and the second touch area can adapt to the mode switching display position of the electronic device. The mode of the electronic device can include a dual-screen display mode of a notebook. For example, the first display area or the first display screen is located on a support plane, and the second display area or the second display screen is located on one side of the support plane, such as above. The first touch area and the second touch area can be displayed on the first display screen. If the user changes the positions of the first display screen and the second display screen to cause the second display screen to be located on the support plane and the first display screen to be located on one side of the support plane, such as above, the display positions of the first touch area and the second touch area can be changed to allow the first touch area and the second touch area to be displayed on the second display screen located on the support plane. Further, the application interface targeted by the first touch area and the second touch area can be switched to be displayed on the first display screen.

The electronic device can also include a sharing mode. After the electronic device is opened to a certain angle, such as about 180 degrees, the user located on the first display screen and the user on the second display screen can see the same display content in a forward direction. If the first touch area and the second touch area are invoked on one display screen, the first touch area and the second touch area can also be invoked on the other display screen. Alternatively, according to the mode settings of the sharing mode, the first touch area and the second touch area can be displayed only on the display screen of the main operator and not on the display screen of the viewer.

The electronic device can also include a physical keyboard. The physical keyboard can cover the first display screen or the second display screen. When the physical keyboard covers any display screen, all content displayed on the display screen can be moved to the other display screen for display. If a display screen displays the first touch area and the second touch area, and the display screen is covered by the physical keyboard, the first touch area and the second touch area can be moved to the other display screen for display. In some other embodiments, with the coverage of the physical keyboard, the probability of the user using the physical keyboard can be increased, which can trigger the first touch area and the second touch area to be closed.

Embodiments of the present disclosure can also provide a control apparatus 100. As shown in FIG. 8, the control apparatus 100 includes an acquisition module 101 and a response module 102. The acquisition module 101 is configured to obtain a touch operation. The response module 102 can be configured to control the input state of the electronic device in response to the touch operation. The input state of the electronic device can include at least a first input state and a second input state. In the first input state, the first display area 1 of the electronic device includes the first touch area 2. In the second input state, the first display area 1 of the electronic device includes the second touch area 3, which covers at least a part of the first touch area 2.

In some embodiments, the acquisition module 101 can be further configured to obtain the touch operation in the target area of the first touch area 2. The target area can be the area not covered by the second touch area 3. The response module 102 can be further configured to control the input state of the electronic device in response to the touch operation in the target area of the first touch area 2.

In some embodiments, the control apparatus 100 can further include a control module. The control module can be configured to, when the electronic device is in the first input state, and the touch operation obtained in the target area of the first touch area 2 is a first touch operation, control the electronic device to enter the second input state, and when the electronic device is in the second input state, and the touch operation obtained in the target area of the first touch area 2 is the second touch operation, control the electronic device to enter the first input state.

In some embodiments, the control apparatus 100 can further include a control module. The control module can be further configured to, when the electronic device is in the second input state, obtain the first adjustment operation on the first touch area 2. The first adjustment operation can be at least used to adjust the position and/or open/closed state of the first touch area 2. The control module can be further configured to synchronously adjust the first touch area 2 and the second touch area 3 based on the first adjustment operation.

In some embodiments, the control apparatus 100 can further include a control module. The control module can be further configured to, when the electronic device is in the second input state, set the portion of the first touch area 2 not covered by the second touch area 3 to be in the non-response state, and control the electronic device to switch from the second input state to the first input state in response to the close operation on the second touch area 3.

In some embodiments, the control apparatus 100 can further include a control module. The control module can be further configured to, when the electronic device is in the second input state, set the portion of the first touch area 2 not covered by the second touch area 3 to be in the response state, control the electronic device to switch from the second input state to the first input state in response to the touch operation in the target area of the first touch area 2, or control the electronic device to switch from the second input state to the first input state in response to the selection operation on the close option of the second touch area 3.

In some embodiments, the control apparatus 100 can further include a control module. The control module can be further configured to, when the obtained touch operation indicates that the electronic device enters the third input state, display the first touch area 2 and the second touch area 3 side by side, and when adjusting the position of one of the first touch area 2 and the second touch area 3 in the third input state, synchronously change the position of the other one to cause the first touch area 2 and the second touch area 3 to remain being displayed independently.

In some embodiments, the control apparatus 100 can further include a control module. The control module can be further configured to obtain the second adjustment operation for adjusting the second touch area 3, and adjust the display parameters of the second touch area 3 in the second input state based on the second adjustment operation.

In some embodiments, the control apparatus 100 can further include a control module. The control module can be further configured to, based on the second adjustment operation, adjust at least one of the display positions, display effect, or display size of the second touch area 3 within the range of the first touch area 2 in the second input state.

According to embodiments of the present disclosure, the units can be implemented as computer-executable instructions stored in memory that, when executed by a processor, cause the processor to implement corresponding processes. The units can also be implemented as hardware with corresponding logical computing capabilities or a combination of software and hardware (firmware). In some embodiments, the processor can be implemented as any one of FPGA, ASIC, DSP chip, SOC (System on Chip), MPU (e.g., but not limited to Cortex), etc. The processor can be communicatively coupled with the memory and configured to execute the computer-executable instructions stored in the memory. The memory can include read-only memory (ROM), flash memory, random access memory (RAM), dynamic random access memory (DRAM) such as synchronous DRAM (SDRAM) or Rambus DRAM, static memory (e.g., flash memory, static random access memory), etc., on which computer-executable instructions can be stored in any format. The computer-executable instructions can be accessed by the processor, read from ROM or any other suitable storage location, and loaded into RAM for execution by the processor to implement the wireless communication method according to embodiments of the present disclosure.

In the various components of the system of the present disclosure, the components can be logically divided based on the functions the components are intended to achieve. However, the present disclosure is not limited to this, and the components can be re-divided or combined as needed. For example, some components can be combined into a single component, or some components can be further divided into more sub-components.

Component embodiments of the present disclosure can be implemented in hardware, or as software modules running on one or more processors, or as a combination thereof. Those skilled in the art should understand that, in practice, a microprocessor or digital signal processor (DSP) can be configured to implement some or all of the functions of some or all of the components in the system according to embodiments of the present disclosure. The present disclosure can also be implemented as a device or apparatus program (e.g., a computer program or computer program product) for executing a part or all of the methods described here. Thus, the program implementing the present disclosure can be stored on a computer-readable medium or can include the form of one or more signals. Such signals can be downloaded from an Internet website, provided on a carrier signal, or provided in any other form. In addition, the present disclosure can be implemented using hardware including several different components and using appropriately programmed computers. In unit claims listing several apparatuses, several of the apparatuses can be embodied by the same hardware item. The use of words such as first, second, and third does not indicate any order, which can be interpreted as names.

Furthermore, although exemplary embodiments have been described here, the scope includes any and all embodiments based on the present disclosure having equivalent elements, modifications, omissions, combinations (e.g., cross-schemes of various embodiments), adaptations, or changes. The elements in the claims will be interpreted broadly based on the language used in the claims and are not limited to the examples described in the specification or during the implementation of the present disclosure. The embodiments are interpreted as non-exclusive.

The above description is intended to be illustrative rather than restrictive. For example, the above examples (or one or more schemes thereof) can be used in combination with each other. For example, other embodiments can be used by those of ordinary skill in the art upon reading the above description. Additionally, in the above detailed description, various features can be grouped together to simplify the present disclosure. This should not be interpreted as an intention that any unclaimed disclosed feature is essential to any claim. On the contrary, the subject matter of the present disclosure can include fewer than all features of the specific disclosed embodiments. Thus, the claims are incorporated into the detailed description as examples or embodiments, with each claim standing independently as a separate embodiment, and these embodiments can be combined with each other in various combinations or arrangements. The scope of the present disclosure should be determined with reference to the appended claims and the full scope of equivalents to which such claims are entitled.

The above embodiments are merely exemplary embodiments of the present disclosure and are not intended to limit the present disclosure. The scope of protection of the present disclosure is defined by the claims. Those skilled in the art can make various modifications or equivalent substitutions to the present disclosure within the spirit and scope of the present disclosure, and such modifications or equivalent substitutions should also be within the scope of the present disclosure.

What is claimed is:

1. A control method comprising:
obtaining a touch operation; and
in response to the touch operation, controlling an input state of an electronic device, wherein the input state of the electronic device at least includes a first input state and a second input state, in the first input state, a first display area of the electronic device displays a first touch area, and in the second input state, the first display area of the electronic device displays a second touch area that at least covers a portion of the first touch area.

2. The control method according to claim 1, wherein:
obtaining the touch operation includes:
obtaining the touch operation in a target area of the first touch area, wherein the target area is an area not covered by the second touch area;
controlling the input state of the electronic device in response to the touch operation includes:
controlling the input state of the electronic device in response to the touch operation in the target area of the first touch area.

3. The control method according to claim 2, further comprising:
in response to the electronic device being in the first input state and the touch operation obtained in the target area of the first touch area being a first touch operation, controlling the electronic device to enter the second input state; and
in response to the electronic device being in the second input state and the touch operation obtained in the target area of the first touch area being a second touch operation, controlling the electronic device to enter the first input state.

4. The control method according to claim 1, further comprising:
in response to the electronic device being in the second input state, obtaining a first adjustment operation on the first touch area, wherein the first adjustment operation is at least used to adjust a position and/or an open/closed state of the first touch area; and
synchronously adjusting the first touch area and the second touch area based on the first adjustment operation.

5. The control method according to claim 1, further comprising:
in response to the electronic device being in the second input state, a portion of the first touch area not covered by the second touch area being in a non-response state;
in response to a close operation on the second touch area, controlling the electronic device to switch from the second input state to the first input state.

6. The control method according to claim 2, further comprising:
in response to the electronic device being in the second input state, a portion of the first touch area not covered by the second touch area being in a response state;
controlling the electronic device to switch from the second input state to the first input state in response to the touch operation in the target area of the first touch area; or
controlling the electronic device to switch from the second input state to the first input state in response to a selection operation on a close option of the second touch area.

7. The control method according to claim 1,
wherein the input state of the electronic device further includes a third input state, the method further comprising:
in response to the obtained touch operation indicating that the electronic device enters the third input state, displaying the first touch area and the second touch area side by side; and
in response to adjusting a position of one of the first touch area and the second touch area in the third input state, synchronously changing a position of the other one to allow the first touch area and the second touch area to remain displaying independently.

8. The control method according to claim 1, further comprising:
obtaining a second adjustment operation for adjusting the second touch area; and
adjusting at least a display parameter of the second touch area in the second input state based on the second adjustment operation.

9. The control method according to claim 8, wherein adjusting at least the display parameter of the second touch area in the second input state based on the second adjustment operation includes:
based on the second adjustment operation, adjusting at least one of a display position, a display effect, or a display size of the second touch area within a range of the first touch area in the second input state.

10. A control apparatus comprising:
one or more processors; and
one or more memories storing computer instructions that, when executed by the one or more processors, cause the one or more processors to:
obtain a touch operation; and
in response to the touch operation, control an input state of an electronic device, wherein the input state of the electronic device at least includes a first input state and a second input state, in the first input state, a first display area of the electronic device displays a first touch area, and in the second input state, the first display area of the electronic device displays a second touch area that at least covers a portion of the first touch area.

11. The control apparatus according to claim 10, wherein the one or more processors are further configured to:
obtaining the touch operation in a target area of the first touch area, wherein the target area is an area not covered by the second touch area;
controlling the input state of the electronic device in response to the touch operation in the target area of the first touch area.

12. The control apparatus according to claim 11, wherein the one or more processors are further configured to:
in response to the electronic device being in the first input state and the touch operation obtained in the target area of the first touch area being a first touch operation, control the electronic device to enter the second input state; and
in response to the electronic device being in the second input state and the touch operation obtained in the target area of the first touch area being a second touch operation, control the electronic device to enter the first input state.

13. The control apparatus according to claim 10, wherein the one or more processors are further configured to:
in response to the electronic device being in the second input state, obtain a first adjustment operation on the first touch area, wherein the first adjustment operation is at least used to adjust a position and/or an open/closed state of the first touch area; and
synchronously adjust the first touch area and the second touch area based on the first adjustment operation.

14. The control apparatus according to claim 10, wherein the one or more processors are further configured to:
in response to the electronic device being in the second input state, cause a portion of the first touch area not covered by the second touch area to be in a non-response state;
in response to a close operation on the second touch area, control the electronic device to switch from the second input state to the first input state.

15. The control apparatus according to claim 11, wherein the one or more processors are further configured to:
in response to the electronic device being in the second input state, cause a portion of the first touch area not covered by the second touch area to be in a response state;
control the electronic device to switch from the second input state to the first input state in response to the touch operation in the target area of the first touch area; or
control the electronic device to switch from the second input state to the first input state in response to a selection operation on a close option of the second touch area.

16. The control apparatus according to claim 10, wherein the input state of the electronic device further includes a third input state, and the one or more processors are further configured to:
in response to the obtained touch operation indicating that the electronic device enters the third input state, display the first touch area and the second touch area side by side; and
in response to adjusting a position of one of the first touch area and the second touch area in the third input state, synchronously change a position of the other one to allow the first touch area and the second touch area to remain displaying independently.

17. The control apparatus according to claim 10, wherein the one or more processors are further configured to:
obtain a second adjustment operation for adjusting the second touch area; and
adjust at least a display parameter of the second touch area in the second input state based on the second adjustment operation.

18. The control apparatus according to claim 17, wherein the one or more processors are further configured to:
based on the second adjustment operation, adjust at least one of a display position, a display effect, or a display size of the second touch area within a range of the first touch area in the second input state.
